(19) United States
(12) Patent Application Publication
(10) Pub. No.: US 2020/0159765 A1
(43) Pub. Date: May 21, 2020

(54) PERFORMING IMAGE SEARCH USING CONTENT LABELS

(71) Applicant: Google LLC, Mountain View, CA (US)

(72) Inventors: Dmitri Yurievich Manin, Menlo Park, CA (US); Suddha Kalyan Basu, San Jose, CA (US); Sushrut Karanjkar, Cupertino, CA (US)

(21) Appl. No.: 16/264,218

(22) Filed: Jan. 31, 2019

Related U.S. Application Data
(60) Provisional application No. 62/770,478, filed on Nov. 21, 2018.

(51) Int. Cl. G06F 16/583; G06F 16/2457; G06F 16/53; G06F 16/58; G06N 3/02

(52) U.S. Cl. CPC G06F 16/583; G06F 16/24578; G06K 9/00624; G06F 16/5866; G06N 3/02; G06F 16/53

(57) ABSTRACT

Methods, systems, and apparatus, including computer programs encoded on a computer storage medium, for performing image search. In one aspect, a system receives a request for images responsive to a provided search query including one or more search terms. The system obtains content labels for the provided search query which represent entities depicted in images identified by search results previously generated by a search system by processing search queries comprising search terms included in the provided search query. The system uses the content labels for the provided search query to determine a relevance score for each of multiple candidate images. The system determines a ranking of the candidate images based in part on the relevance scores for the candidate images.

### CROSS-REFERENCE TO RELATED APPLICATIONS

This application claims the benefit under 35 U.S.C. § 119(e) of U.S. Patent Application No. 62/770,478, entitled “PERFORMING IMAGE SEARCH USING CONTENT LABELS,” filed Nov. 21, 2018. The disclosure of the foregoing application is incorporated herein by reference in its entirety for all purposes.

### BACKGROUND

This specification relates to information retrieval.

The Internet provides access to a wide variety of electronic documents, such as image files, audio files, video files, and webpages. A search system can identify electronic documents that are responsive to search queries. The search queries can include one or more search terms, images, audio data, or a combination thereof. Searching images can present particular challenges.

### SUMMARY

This specification describes a search system implemented as computer programs on one or more computers in one or more locations. The search system can perform an image search by processing a search query that includes one or more search terms to generate search results that identify images responsive to the search query.

According to a first aspect there is provided a method performed by one or more data processing apparatus which includes receiving a request for images responsive to a provided search query including one or more search terms. Content labels are obtained for the provided search query, where the content labels for the provided search query represent entities depicted in images identified by search results previously generated by a search system by processing search queries comprising search terms included in the provided search query. For each of multiple candidate images, content labels are obtained for the candidate image, where each content label for the candidate image represents an entity depicted by the candidate image. A relevance score is determined for the candidate image based on a similarity measure that measures a similarity of: (i) the content labels for the provided search query, and (ii) the content labels for the candidate image. A ranking of the candidate images is determined based in part on the relevance scores for the candidate images. Search results identifying one or more of the candidate images are provided in response to the request based on the ranking of the candidate images.

In some implementations, the content labels for the provided search query include terms representing entities depicted in images identified by search results previously generated by the search system by processing the provided search query.

In some implementations, the content labels for the provided search query include terms representing entities depicted in images identified by search results previously generated by the search system by processing a search query defined by a sequence of one or more search terms included in the provided search query.

In some implementations, the content labels for the provided search query include terms representing entities depicted in images identified by search results previously generated by the search system by processing a search query which includes a sequence of one or more search terms which are also included in the provided search query.

In some implementations, the content labels for the provided search query are determined based on respective user selection rates of the search results generated by the search system by processing search queries comprising search terms included in the provided search query.

In some implementations, the content labels for the candidate images are generated by processing the candidate images using an entity detection model to generate data defining entities depicted by the candidate image; and the content labels for the provided search query are generated by processing, using an entity detection model, images identified by search results previously generated by the search system by processing search queries comprising search terms included in the provided search query.

In some implementations, the entity detection model comprises an object detection neural network.

In some implementations, obtaining content labels for the candidate image includes obtaining one or more content labels which each represent a respective object depicted by the candidate image.

In some implementations, obtaining content labels for the provided search query includes obtaining one or more content labels which each represent a respective object depicted by an image identified by search results previously generated by the search system by processing search queries comprising search terms included in the provided search query.

In some implementations, determining a relevance score for the candidate image based on a similarity measure that measures a similarity of: (i) the content labels for the provided search query to (ii) the content labels for the candidate image, includes determining a cosine similarity measure between: (i) a numerical representation of the content labels for the provided search query, and (ii) a numerical representation of the content labels for the candidate image.

In some implementations, the similarity measure is based on a respective likelihood of each of: (i) the content labels for the provided search query, and (ii) the content labels for the candidate image.

In some implementations, providing data identifying one or more of the candidate images in response to the request based on the ranking of the plurality of candidate images includes providing data identifying one or more highest-ranked candidate images in response to the request.

According to a second aspect there is provided a system including one or more computers and one or more storage devices storing instructions that when executed by the one or more computers cause the one or more computers to perform operations including the operations of the previously described method.

According to a third aspect there is provided one or more non-transitory computer storage media storing instructions that when executed by one or more computers cause the one or more computers to perform operations including the operations of the previously described method.

Particular embodiments of the subject matter described in this specification can be implemented so as to realize one or more of the following advantages.

The search system described in this specification can identify images responsive to a search query. The search system uses a set of content labels obtained for the search query to identify images and can efficiently determine a set of content labels for any search query using pre-computed data, thus reducing any latency in providing images responsive to search queries. More specifically, for each of a large number (e.g., millions) of search queries, the search system can pre-compute (i.e., by identifying and storing) content labels which represent entities depicted in images identified by search results previously generated by the search system by processing the search query.

The search system can obtain a set of content labels for a given search query by aggregating pre-computed content labels from images corresponding to one or more of: (i) the given search query, (ii) “sub-queries” of the search query, and (iii) search queries “related” to the given search query. A sub-query of the given search query is defined by a sequence of one or more search terms included in the given search query. Two search queries are said to be “related” if they both include a same sub-query. In this manner, the search system can determine content labels for a given search query using pre-computed data even if content labels from images corresponding to the given search query are not pre-computed. More specifically, even if content labels from images corresponding to the given search query are not pre-computed, the system can determine content labels for the given search query by aggregating pre-computed content labels from images corresponding to sub-queries and related search queries of the given search query. This is a technical improvement in the field of information retrieval and image search.

The search system described in this specification can determine a relevance score which characterizes the relevance of an image to a search query using criteria that are easily understood and interpretable by a person. In particular, the search system determines the relevance score based on: (i) a set of content labels for the search query, and (ii) a set of content labels for the image. The respective sets of content labels for the search query and for the image can be easily understood and interpreted by a person, which can facilitate efficient calibration and debugging of the search system. In contrast, other scores which characterize the relevance of an image to a search query may be based on complex and non-interpretable criteria (e.g., the outputs of neural networks) which may significantly increase the difficulty of calibrating and debugging the search system. This is another technical improvement in the field of information retrieval and image search.

By determining search results for search queries based on relevance scores computed using content labels, the search system described in this specification can generate improved image search results in response to search queries. In this manner, the search system can reduce computational resource consumption (e.g., memory, computing power, or both) by reducing the number of search queries transmitted by users to retrieve relevant data. For example, experiments have shown that manual search query refinements (i.e., where a user is unsatisfied with the search results provided in response to a search query) decreased by 0.35% when the search system determined search results based on relevance scores computed using content labels. Moreover, experiments have also shown that the rate at which users select the first search result provided by the search system increases by 1.6% when the search system determined search results based on relevance scores computed using content labels. This is another technical improvement in the field of information retrieval and image search.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example search system.

FIG. 2 shows an example ranking engine.

FIG. 3 is a flow diagram of an example process for providing image search results responsive to a search query that includes one or more search terms.

FIG. 4 is a flow diagram of an example process for obtaining content labels for a given search query that includes one or more search terms.

Like reference numbers and designations in the various drawings indicate like elements.

### DETAILED DESCRIPTION

This specification describes a search system that can perform an image search by processing a search query that includes one or more search terms to generate search results that identify images responsive to the search query. The search system is configured to process the search query to determine a respective relevance score for each of one or more candidate images, where the relevance score for a candidate image characterizes a relevance of the candidate image to the search query. The search system determines a ranking of the candidate images based (at least in part) on the relevance scores of the candidate images, and can generate search results which identify one or more highest-ranked candidate images.

To generate the relevance score for a candidate image, the search system determines: (i) a set of content labels for the search query, and (ii) a set of content labels for the candidate image, and computes a similarity measure between the respective sets of content labels. The content labels for the search query are terms representing entities (e.g., objects) depicted in images which are identified by search results previously generated by the search system for one or more of: (i) the search query, (ii) “sub-queries” of the search query, and (iii) “related” search queries. The content labels for the candidate image represent entities (e.g., objects) that are depicted by the candidate image. The search system can determine entities depicted in an image by processing the image using an entity detection model (e.g., which may include an object detection neural network).

These features and other features are described in more detail below.

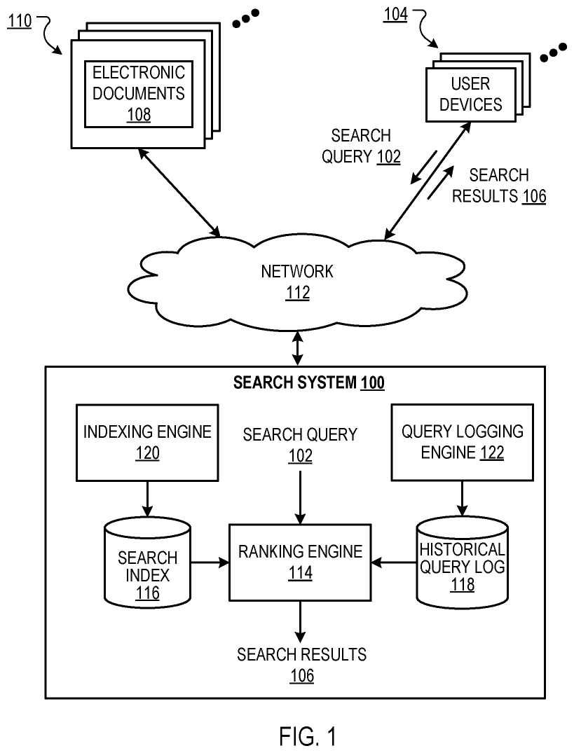

FIG. 1 shows an example search system 100. The search system 100 is an example of a system implemented as computer programs on one or more computers in one or more locations in which the systems, components, and techniques described below are implemented.

The search system 100 is configured to receive a search query 102 from a user device 104, to process the search query 102 to determine one or more search results 106 responsive to the search query 102, and to provide the search results 106 to the user device 104. The search query 102 can include search terms expressed in a natural language (e.g., English), images, audio data, or any other appropriate form of data. A search result 106 identifies an electronic document 108 from a website 110 that is responsive to the search query 102, and includes a link to the electronic document 108. Electronic documents 108 can include, for example, images, HTML webpages, word processing documents, portable document format (PDF) documents, and videos. The electronic documents 108 can include content, such as words, phrases, images, and audio data, and may include embedded information (e.g., meta information and hyperlinks) and embedded instructions (e.g., scripts). A website 110 is a collection of one or more electronic documents 108 that is associated with a domain name and hosted by one or more servers. For example, a website 110 may be a collection of webpages formatted in hypertext markup language (HTML) that can contain text, images, multimedia content, and programming elements (e.g., scripts).

In a particular example, a search query 102 can include the search terms “Apollo moon landing”, and the search system 100 may be configured to perform an image search, that is, to provide search results 106 which identify respective images that are responsive to the search query 102. In particular, the search system 100 may provide search results 106 that each include: (i) a title of a webpage, (ii) a representation of an image extracted from the webpage, and (iii) a hypertext link (e.g., specifying a uniform resource locator (URL)) to the webpage or to the image itself. In this example, the search system 100 may provide a search result 106 that includes: (i) the title “Apollo moon landing” of a webpage, (ii) a reduced-size representation (i.e., thumbnail) of an image of the Apollo spacecraft included in the webpage, and (iii) a hypertext link to the image.

A computer network 112, such as a local area network (LAN), wide area network (WAN), the Internet, a mobile phone network, or a combination thereof, connects the websites 110, the user devices 104, and the search system 100 (i.e., enabling them to transmit and receive data over the network 112). In general, the network 112 can connect the search system 100 to many thousands of websites 110 and user devices 104.

A user device 104 is an electronic device that is under control of a user and is capable of transmitting and receiving data (including electronic documents 108) over the network 112. Example user devices 104 include personal computers, mobile communication devices, and other devices that can transmit and receive data over the network 112. A user device 104 typically includes user applications (e.g., a web browser) which facilitate transmitting and receiving data over the network 112. In particular, user applications included in a user device 104 enable the user device 104 to transmit search queries 102 to the search system 100, and to receive the search results 106 provided by the search system 100 in response to the search queries 102, over the network 112.

The user applications included in the user device 104 can present the search results 106 received from the search system 100 to a user of the user device (e.g., by rendering a search results page which shows an ordered list of the search results 106). The user may select one of the search results 106 presented by the user device 104 (e.g., by clicking on a hypertext link included in the search result 106), which can cause the user device 104 to generate a request for an electronic document 108 identified by the search result 106. The request for the electronic document 108 identified by the search result 106 is transmitted over the network 112 to a website 110 hosting the electronic document 108. In response to receiving the request for the electronic document 108, the website 110 hosting the electronic document 108 can transmit the electronic document 108 to the user device 104.

The search system 100 processes a search query 102 using a ranking engine 114 to determine search results 106 responsive to the search query 102. As will be described in more detail below, the ranking engine 114 determines search results 106 responsive to the search query 102 using a search index 116 and a historical query log 118.

The search system 100 uses an indexing engine 120 to generate and maintain the search index 116 by “crawling” (i.e., systematically browsing) the electronic documents 108 of the websites 110. For each of a large number (e.g., millions) of electronic documents 108, the search index 116 indexes the electronic document by maintaining data which: (i) identifies the electronic document 108 (e.g., by a link to the electronic document 108), and (ii) characterizes the electronic document 108. The data maintained by the search index 116 which characterizes an electronic document may include, for example, data specifying a type of the electronic document (e.g., image, video, PDF document, and the like), a quality of the electronic document (e.g., the resolution of the electronic document when the electronic document is an image or video), keywords associated with the electronic document, a cached copy of the electronic document, or a combination thereof.

The search system 100 can store the search index 116 in a data store which may include thousands of data storage devices. The indexing engine 120 can maintain the search index 116 by continuously updating the search index 116, for example, by indexing new electronic documents 108 and removing electronic documents 108 that are no longer available from the search index 116.

The search system 100 uses a query logging engine 122 to generate and maintain a historical query log 118. For each of a large number (e.g., millions) of search queries previously processed by the search system 100, the historical query log 118 indexes the previous search query by maintaining data which specifies: (i) the previous search query, (ii) search results provided by the search system 100 in response to the previous search query, and (iii) user selection data which specifies one or more of the search results that were selected by the user of the user device which transmitted the previous search query. As described earlier, a user can select a search result by, for example, clicking on a hypertext link included in the search result to generate a request for the electronic document identified by the search result. More generally, the user selection data can be understood as any data characterizing a level of “interest” of the user in search results transmitted in response to a search query. For example, the user selection data can be based on “hover data”, which characterizes how long a user hovers their cursor over a search result. Hovering a cursor over the search result may cause more information relevant to the search result to be displayed. For example, if the search result is an image, hovering a cursor over the search result may cause an enlarged version of the image to be displayed.

The search system 100 can store the historical query log 118 in a data store which may include thousands of data storage devices. The query logging engine 122 can maintain the historical query log 118 by continuously updating the historical query log 118 (e.g., by indexing new search queries as they are processed by the search system 100).

The ranking engine 114 determines search results 106 responsive to the search query 102 by scoring electronic documents 108 indexed by the search index 116. The ranking engine 114 can score electronic documents 108 based in part on data accessed from the historical query log 118. The score determined by the ranking engine 114 for an electronic document 108 characterizes how responsive (e.g., relevant) the electronic document is to the search query 102. The ranking engine 114 determines a ranking of the electronic documents 108 indexed by the search index 116 based on their respective scores, and determines the search results based on the ranking. For example, the ranking engine 114 can generate search results 106 which identify the highest-ranked electronic documents 108 indexed by the search index 116.

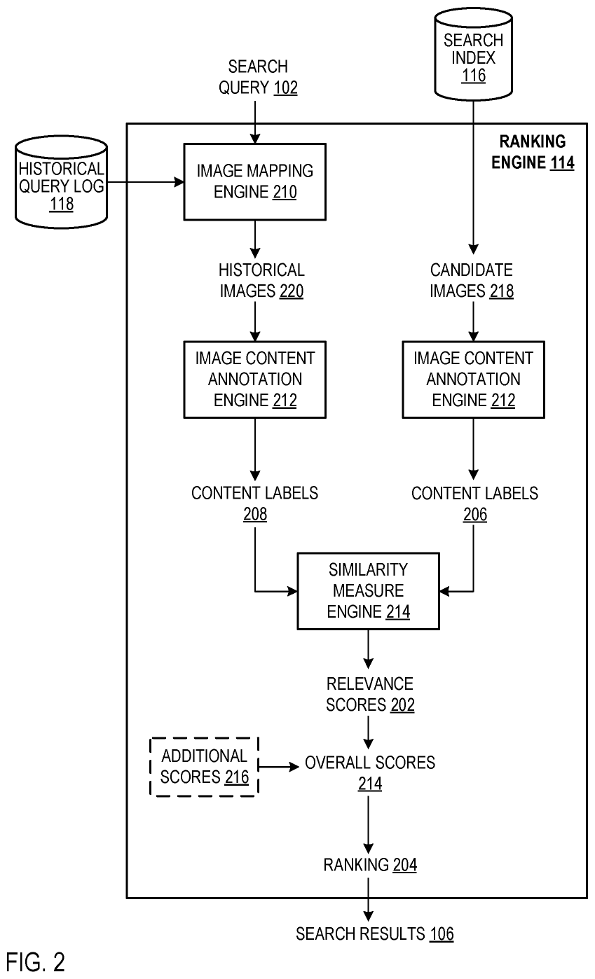

FIG. 2 shows an example ranking engine 114. The ranking engine 114 is an example of an engine implemented as computer programs on one or more computers in one or more locations in which the systems, components, and techniques described below are implemented. As described with reference to FIG. 1, the ranking engine 114 of the search system 100 can process search queries of any appropriate format to generate search results identifying electronic documents of any appropriate format. For example, the search queries processed by the ranking engine may include, for example, search terms, images, audio data, or a combination thereof, and the electronic documents identified by the search results may include, for example, images, HTML webpages, word processing documents, portable document format (PDF) documents, and videos. FIG. 2 depicts specific components of the ranking engine 114 that can be used to perform an image search by processing a search query 102 that includes one or more search terms to generate search results 106 that identify images responsive to the search query 102.

The ranking engine 114 generates the search results 106 by determining a respective relevance score 202 for each of multiple images indexed by the search index 116 and determining a ranking 204 of the images based at least in part on the relevance scores 202. The ranking engine 114 determines the relevance score 202 for an image based on a similarity measure between: (i) a set of content labels 206 for the image, and (ii) a set of content labels 208 for the search query 102, as will be described in more detail below.

The ranking engine 114 processes each of multiple “candidate” images 218 indexed by the search index 116 using an image content annotation engine 212 to generate a respective set of content labels 206 for each of the candidate images 218. In some cases, the candidate images 218 may include every image indexed by the search index 116, while in other cases, the candidate images 218 may include only a proper subset of the images indexed by the search index 116. In a particular example, the ranking engine 114 may determine an initial ranking of the images indexed by the search index 116 using a “fast” ranking method that can be performed quickly and consumes few computational resources. The initial ranking of the images indexed by the search index 116 can approximately (i.e., roughly) rank images based on how responsive they are to the search query 102. After determining the initial ranking of the images indexed by the search index 116, the ranking engine 114 can determine a set of highest-ranked images according to the initial ranking method as the candidate images 218.

The image content annotation engine 212 is configured to generate content labels 206 for an image which represent “entities” depicted by the image. An entity depicted by the image may be, for example: (i) an object depicted by the image, (ii) a characteristic of an object depicted by the image, or (iii) a global characteristic of the image. An object depicted by the image may be a high-level object (e.g., vehicle), or a specific object (e.g., Ford Mustang). A characteristic of an object depicted by the image may be, for example, a color of an object depicted in the image (e.g., green), an emotion expressed by a person depicted in the image (e.g., happy), or an action performed by a person depicted in the image (e.g., running). A global characteristic of an image refers to data characterizing the image as a whole rather than a specific object in the image, for example, a state of weather depicted in the image (e.g., sunny, cloudy, or rainy), or a location at which the image was captured (e.g., Paris). The image content annotation engine 212 can pre-compute the content labels 206 for each image indexed by the search index 116 to reduce any latency in generating the search results 106.

The ranking engine 114 processes the search query 102 using an image mapping engine 210 which maps the search query 102 to a set of historical images 220. The historical images 220 are images identified by search results previously generated by the search system 100 for one or more of: (i) the search query 102, (ii) “sub-queries” of the search query 102, and (iii) search queries “related” to the search query 102. A sub-query of the search query 102 is defined by a sequence of one or more search terms included in the search query 102. For example, “moon landing” is a sub-query of the search query “Apollo moon landing”. Two search queries are said to be “related” if they both include a same sub-query. For example, the search query “Apollo moon landing” is related to the search query “American moon landing” (i.e., since they both include the sub-query “moon landing”). The image mapping engine 210 uses the historical query log 118 to determine search results previously generated by the search system 100 for search queries. The image mapping engine 210 may map the search query 102 to the historical images 220 based on user selection rates of previous search queries. For example, the image mapping engine 210 may be more likely to map the search query 102 to historical images 220 identified by search results which were more frequently selected by users when provided in response to the search query 102. Generally, the historical images 220 may be images included in the search index 116.

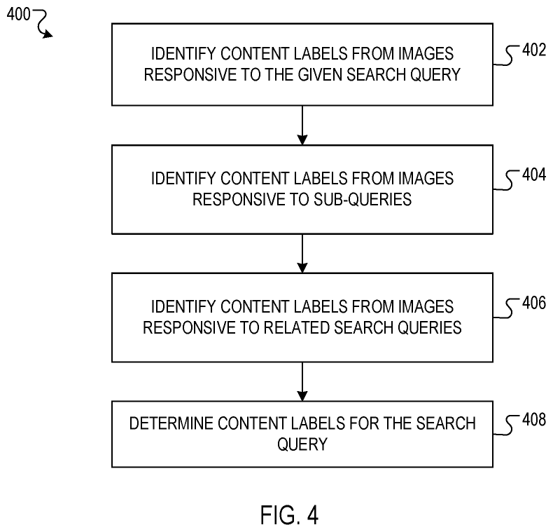

The ranking engine 114 generates the content labels 208 for the search query 102 by processing the historical images 220 using the image content annotation engine 212. In a particular example, for the search query “Apollo moon landing”, the ranking engine 114 may determine content labels 208 for the search query which include: “space”, “astronaut”, “emblem”, “vehicle”, “symbol”, “spacecraft”, “badge”, “circle”, “logo”, “rocket”, and “aerospace engineering”. An example process for generating content labels for a search query is described in more detail with reference to FIG. 4.

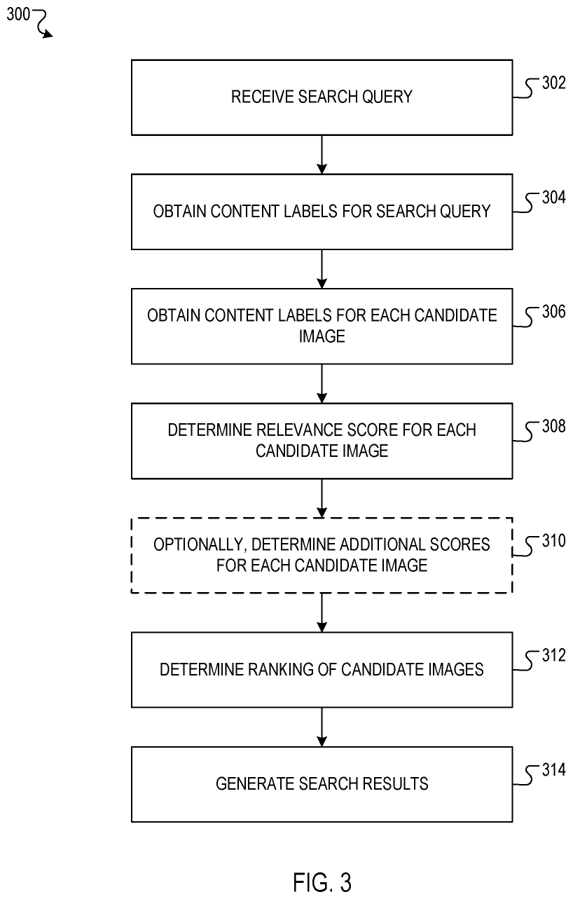

The ranking engine 114 uses a similarity measure engine 214 to process: (i) the content labels 208 for the search query 102, and (ii) the respective content labels 206 for each candidate image, to generate a respective relevance score 202 for each candidate image. The relevance score 202 for a candidate image is a numerical value which characterizes a relevance of the candidate image to the search query 102. Optionally, the ranking engine 114 can compute one or more additional scores for each candidate image, and determine a respective overall score 214 for each candidate image based on: (i) the relevance score 202 for the candidate image, and (ii) the additional scores 216 for the candidate image. For example, the ranking engine 114 may determine the overall score 214 for a candidate image to be a weighted sum of the relevance score 202 for the candidate image and the additional scores 216 for the candidate image. Examples of additional scores 216 are described further with reference to FIG. 3.

The ranking engine 114 determines a ranking 204 of the candidate images 218 based on the overall scores 214 (or, if there are no additional scores 216, the relevance scores 202) and generates the search results 106 based on the ranking 204. For example, the ranking engine 114 can generate search results 106 which identify the highest-ranked candidate images 218.

FIG. 3 is a flow diagram of an example process 300 for providing image search results responsive to a search query that includes one or more search terms. For convenience, the process 300 will be described as being performed by a system of one or more computers located in one or more locations. For example, a search system, e.g., the search system 100 of FIG. 1, appropriately programmed in accordance with this specification, can perform the process 300.

The search system receives a search query that includes one or more search terms (302). As described with reference to FIG. 1, the search query may be transmitted to the search system over a computer network by a user device of a user. An example of a search query that includes one or more search terms is: “Apollo moon landing”.

The search system obtains content labels for the search query (304). The content labels for the search query are terms representing entities depicted by images which are identified by search results previously generated by the search system for one or more of: (i) the search query, (ii) “sub-queries” of the search query, and (iii) “related” search queries. An example process for obtaining content labels for a search query is described with reference to FIG. 4.

For each of multiple candidate images indexed by the search index, the search system obtains respective content labels for the candidate image which represent entities depicted by the candidate image (306). As described with reference to FIG. 2, an entity depicted by an image may be, for example: (i) an object depicted by the image, (ii) a characteristic of an object depicted by the image, or (iii) a global characteristic of the image. The search system can generate the content labels for an image by processing the image using an entity detection model. For example, the entity detection model may be an entity detection neural network system which includes an object detection neural network. In this example, the object detection neural network may be configured to process an image to generate object detection data which includes data defining object classes of objects depicted in the image. The system may determine the object classes of the objects depicted in the image to be content labels for the image. In some cases, the system determines a predetermined number of content labels for each candidate image, while in other cases, the system determines a variable number of content labels for each candidate image. For example, the system may determine a variable number of content labels for each candidate image by determining the content labels for a candidate image to include the object classes of objects detected in the candidate image by an object detection network with at least a threshold “confidence” (e.g., 90%). The system can pre-compute the content labels for each image indexed by the search index to reduce any latency in generating search results responsive to the search query. Other appropriate processes and systems for generating content labels may also be used.

In some cases, the candidate images include every image indexed by the search index, while in other cases, the candidate images include a proper subset of the images indexed by the search index. For example, the candidate images may be a set of highest-ranked images according to an initial ranking of the images indexed by the search index by a fast ranking method (as described with reference to FIG. 2).

The system determines a respective relevance score for each of the candidate images (308). The relevance score for a candidate image is a numerical value which characterizes a relevance of the candidate image to the search query. The system determines the relevance score for a candidate image based on a similarity measure that measures a similarity of: (i) the content labels for the candidate image, and (ii) the content labels for the search query. For example, the system may determine a vector representation of the content labels for the candidate image and a vector representation of the content labels for the search query, and thereafter determine the similarity measure based on a cosine similarity measure or a Euclidean distance between the respective vector representations. The system can determine a vector representation of a set of content labels in any of a variety of ways. For example, the vector representation for a given set of content labels may have a respective component for each “possible” content label, where those components of the vector corresponding to content labels in the given set of content labels have value one, and all other components have value zero. A possible content label refers to a content label included in a predetermined set of possible content labels.

In some cases, the system determines the similarity measure based on respective “likelihoods” of different content labels. The likelihood of a content label characterizes how often the system associates the content label with search queries and images. For example, a content label such as “vehicle” may have a higher likelihood than a more specific content label such as “Ford Mustang”. In particular, a content label with a low likelihood that is common to both the search query and the candidate image may impact the similarity measure more than a content label with a high likelihood that is common to both the search query and the candidate image. In one example, the system may determine the similarity measure based on respective likelihoods of different content labels by using a weighted cosine similarity measure, where a function of the likelihood of each content label is used as a weight in the cosine similarity measure.

Optionally, the system determines one or more additional scores for each candidate image (310). In some cases, the system may have determined some or all of the additional scores for the candidate images while generating the initial ranking of the images indexed by the search index using the fast ranking method (as described previously). In one example, the system may determine an additional score for a candidate image based on a visual quality of the candidate image (e.g., an image resolution of the candidate image). As another example, the system may determine an additional score for a candidate image based on how many of the search terms of the search query are included in metadata tags associated with the candidate image. As another example, the system may determine an additional score for a candidate image based on how frequently the candidate image has been selected by users when the system has provided search results identifying the candidate image in response to the search query (e.g., based on the historical data log).

The system determines a ranking of the candidate images based on the relevance scores for each candidate image (312). For example, the system may determine an overall score for each candidate image which characterizes how responsive the candidate image is to the search query based on: (i) the relevance score for the candidate image, and (ii) any additional scores for the candidate image. In a particular example, the system may determine the overall score for a candidate image as a weight sum of the relevance score for the candidate image and any additional scores for the candidate image. The ranking of the candidate images may define an ordering of the candidate images from those with the highest overall scores to those with the lowest overall scores.

The system generates search results responsive to the search query based on the ranking of the candidate images (314). For example, the system can generate search results which identify a predetermined number of highest-ranked candidate images according to the ranking of the candidate images determined based on the relevance scores. After generating the search results, the system can provide the search results for presentation on the user device which generated the search query.

FIG. 4 is a flow diagram of an example process 400 for obtaining content labels for a given search query that includes one or more search terms. For convenience, the process 400 will be described as being performed by a system of one or more computers located in one or more locations. For example, a search system, e.g., the search system 100 of FIG. 1, appropriately programmed in accordance with this specification, can perform the process 400.

The system identifies content labels which represent entities depicted in images that are identified by search results generated by the search system by processing the given search query (402). More specifically, the system can use the historical data log to obtain data specifying: (i) images identified by search results previously generated by the search system by processing the given search query, and (ii) a user selection rate for the search results generated by processing the given search query. The user selection rate for a given search result can specify how often (i.e., relative to other search results) the given search result is selected by users when it is provided by the search system in response to the given search query. For example, the user selection rate may specify that a given search result is selected by users 22% of the time it is provided by the search system in response to the given search query. More generally, the user selection data for a given search result can be descriptive of a level of interest of users in the given search result when it is provided by the search system in response to the given search query. For example, the user selection data for a given search result can be based in part of “hover data” characterizing how long a user hovers a cursor over the given search result when it is provided in response to the given search query. The system may be more likely to identify content labels from images identified by search results with a higher user selection rate (e.g., indicating higher user interest levels). As described previously, the system can identify content labels with represent entities depicted in an image by processing the image using an entity detection model.

In some implementations, the system may have previously identified (i.e., “pre-computed”) content labels for images corresponding to the given search query, and stored the content labels in a data store. The system can access the pre-computed content labels for images corresponding to the given search query from the data store to reduce any latency in determining the content labels for the search query. If the system has not pre-computed content labels for images corresponding to the given search query, the system may refrain from obtaining content labels for images corresponding to the given search query and proceed to step 404.

The system identifies content labels which represent entities depicted in images that are identified by search results generated by the search system by processing sub-queries of the given search query (404). In some cases, the sub-queries may include every possible sub-query of the given search query, while in other cases, the sub-queries may include a predetermined number of sub-queries of the given search query. For example, the sub-queries may include a predetermined number of randomly selected sub-queries of the given search query, or a predetermined number of the most frequently searched sub-queries of the given search query. As described previously, the system can identify content labels with represent entities depicted in an image by processing the image using an entity detection model.

In some implementations, the system may have pre-computed content labels for images corresponding to the sub-queries of the given search query, and stored the content labels in a data store. The system can access the pre-computed content labels for images corresponding to the sub-queries of the given search query from the data store to reduce any latency in determining the content labels for the search query. If the system has not pre-computed content labels for images corresponding to a particular sub-query of the given search query, the system may refrain from obtaining content labels for images corresponding to the particular sub-query.

The system identifies content labels which represent entities depicted in images that are identified by search results generated by the search system by processing search queries related to the given search query (406). The related search queries may include, for example, a predetermined number of most frequently searched related search queries, or a predetermined number of randomly selected related search queries. As described previously, the system can identify content labels with represent entities depicted in an image by processing the image using an entity detection model. In some implementations, the system may have pre-computed content labels for images corresponding to the related search queries, and stored the content labels in a data store. The system can access the pre-computed content labels for images corresponding to the related search queries from the data store to reduce any latency in determining the content labels for the search query. If the system has not pre-computed content labels for images corresponding to a particular related search query, the system may refrain from obtaining content labels for images corresponding to the particular related search query.

The system determines the content labels for the given search query from the content labels identified as described with reference to 402, 404, and 406 (408). For example, the system may determine the content labels to be the set of all content labels identified for images corresponding to the given search query, the sub-queries of the given search query, and the search queries related to the given search query. Any other appropriate method for combining the content labels identified as described with reference to 402, 404, and 406 can be used.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
receiving a request for images responsive to a provided search query comprising one or more search terms;
obtaining content labels for the provided search query, wherein the content labels for the provided search query represent entities depicted in images identified by search results previously generated by a search system by processing search queries comprising search terms included in the provided search query;
for each of a plurality of candidate images:
obtaining content labels for the candidate image, wherein each content label for the candidate image represents an entity depicted by the candidate image; and
determining a relevance score for the candidate image based on a similarity measure that measures a similarity of: (i) the content labels for the provided search query, and (ii) the content labels for the candidate image;
determining a ranking of the candidate images based in part on the relevance scores for the candidate images; and
providing search results identifying one or more of the candidate images in response to the request based on the ranking of the candidate images.

2. The method of claim 1, wherein the content labels for the provided search query comprise terms representing entities depicted in images identified by search results previously generated by the search system by processing the provided search query.

3. The method of claim 1, wherein the content labels for the provided search query comprise terms representing entities depicted in images identified by search results previously generated by the search system by processing a search query defined by a sequence of one or more search terms included in the provided search query.

4. The method of claim 1, wherein the content labels for the provided search query comprise terms representing entities depicted in images identified by search results previously generated by the search system by processing a search query which includes a sequence of one or more search terms which are also included in the provided search query.

5. The method of claim 1, wherein the content labels for the provided search query are determined based on respective user selection rates of the search results generated by the search system by processing search queries comprising search terms included in the provided search query.

6. The method of claim 1, wherein:
the content labels for the candidate images are generated by processing the candidate images using an entity detection model to generate data defining entities depicted by the candidate image; and
the content labels for the provided search query are generated by processing, using an entity detection model, images identified by search results previously generated by the search system by processing search queries comprising search terms included in the provided search query.

7. The method of claim 6, wherein the entity detection model comprises an object detection neural network.

8. The method of claim 1, wherein:
obtaining content labels for the candidate image comprises obtaining one or more content labels which each represent a respective object depicted by the candidate image; and
obtaining content labels for the provided search query comprises obtaining one or more content labels which each represent a respective object depicted by an image identified by search results previously generated by the search system by processing search queries comprising search terms included in the provided search query.

9. The method of claim 1, wherein determining a relevance score for the candidate image based on a similarity measure that measures a similarity of: (i) the content labels for the provided search query to (ii) the content labels for the candidate image, comprises:
determining a cosine similarity measure between: (i) a numerical representation of the content labels for the provided search query, and (ii) a numerical representation of the content labels for the candidate image.

10. The method of claim 1, wherein the similarity measure is based on a respective likelihood of each of: (i) the content labels for the provided search query, and (ii) the content labels for the candidate image.

11. The method of claim 1, wherein providing data identifying one or more of the candidate images in response to the request based on the ranking of the plurality of candidate images comprises:
providing data identifying one or more highest-ranked candidate images in response to the request.

12. A system comprising one or more computers and one or more storage devices storing instructions that when executed by the one or more computers cause the one or more computers to perform operations comprising:
receiving a request for images responsive to a provided search query comprising one or more search terms;
obtaining content labels for the provided search query, wherein the content labels for the provided search query represent entities depicted in images identified by search results previously generated by a search system by processing search queries comprising search terms included in the provided search query;
for each of a plurality of candidate images:
obtaining content labels for the candidate image, wherein each content label for the candidate image represents an entity depicted by the candidate image; and
determining a relevance score for the candidate image based on a similarity measure that measures a similarity of: (i) the content labels for the provided search query, and (ii) the content labels for the candidate image;
determining a ranking of the candidate images based in part on the relevance scores for the candidate images; and
providing search results identifying one or more of the candidate images in response to the request based on the ranking of the candidate images.

13. The system of claim 12, wherein the content labels for the provided search query comprise terms representing entities depicted in images identified by search results previously generated by the search system by processing the provided search query.

14. The system of claim 12, wherein the content labels for the provided search query comprise terms representing entities depicted in images identified by search results previously generated by the search system by processing a search query defined by a sequence of one or more search terms included in the provided search query.

15. The system of claim 12, wherein the content labels for the provided search query comprise terms representing entities depicted in images identified by search results previously generated by the search system by processing a search query which includes a sequence of one or more search terms which are also included in the provided search query.

16. The system of claim 12, wherein the content labels for the provided search query are determined based on respective user selection rates of the search results generated by the search system by processing search queries comprising search terms included in the provided search query.

17. One or more non-transitory computer storage media storing instructions that when executed by one or more computers cause the one or more computers to perform operations comprising:
receiving a request for images responsive to a provided search query comprising one or more search terms;
obtaining content labels for the provided search query, wherein the content labels for the provided search query represent entities depicted in images identified by search results previously generated by a search system by processing search queries comprising search terms included in the provided search query;
for each of a plurality of candidate images:
obtaining content labels for the candidate image, wherein each content label for the candidate image represents an entity depicted by the candidate image; and
determining a relevance score for the candidate image based on a similarity measure that measures a similarity of: (i) the content labels for the provided search query, and (ii) the content labels for the candidate image;
determining a ranking of the candidate images based in part on the relevance scores for the candidate images; and
providing search results identifying one or more of the candidate images in response to the request based on the ranking of the candidate images.

18. The non-transitory computer storage media of claim 17, wherein the content labels for the provided search query comprise terms representing entities depicted in images identified by search results previously generated by the search system by processing the provided search query.

19. The non-transitory computer storage media of claim 17, wherein the content labels for the provided search query comprise terms representing entities depicted in images identified by search results previously generated by the search system by processing a search query defined by a sequence of one or more search terms included in the provided search query.

20. The non-transitory computer storage media of claim 17, wherein the content labels for the provided search query comprise terms representing entities depicted in images identified by search results previously generated by the search system by processing a search query which includes a sequence of one or more search terms which are also included in the provided search query.
